(19) United States
(12) Patent Application Publication
(10) Pub. No.: US 2025/0259038 A1
(43) Pub. Date: Aug. 14, 2025

(54) SYSTEM AND METHOD FOR ANALYSING RAILWAY RELATED DATA

(71) Applicant: KONUX GMBH, Munchen (DE)

(72) Inventor: Andres HERNANDEZ CANSECO, Edingen-Neckarhausen (DE)

(21) Appl. No.: 18/859,191

(22) PCT Filed: Apr. 20, 2024
(86) PCT No.: PCT/EP2023/060363

§ 371 Date: Oct. 23, 2024

(30) Foreign Application Priority Data
Apr. 25, 2022 (EP) 22169843.4

(51) Int. Cl. G06N 3/0455; G06N 3/088

(52) U.S. Cl. CPC G06N 3/0455; G06N 3/088

(57) ABSTRACT

Disclosed is a method for determining a train-type on the basis of railway related vibration data, the method comprising the steps of collecting a first dataset (101-1) of a first train passing a first sensor applied to a first railway segment at a first location; collecting a second dataset (101-2) of a second train passing a second sensor applied to a second railway segment at a second location; encoding the first dataset (101-1) into a first encoded dataset (104-1) comprising at least a first train-type component (102-1) and a first location component (103-1); encoding the second dataset (101-2) into a second encoded dataset (104-2) comprising a second train-type component (102-2) and a second location component (103-2); and feeding the first and the second encoded dataset components (104-1, 104-2) into a neural network (NN) and applying an unsupervised machine learning approach for training the neural network to differentiate between train-types. Furthermore, a corresponding system and computer program product is disclosed.

### FIELD

The invention relates to analyzing and/or monitoring railroads, particularly identifying train types based on sensor data acquired at a railway infrastructure. The invention further relates to unsupervised learning in generative adversarial networks. More specifically, the invention relates a method and system for classifying a train-type based on the sensor data being encoded by the neural network.

### BACKGROUND

With the increase in rail traffic, rail system is under increasing pressure to keep the trains running on time and for longer. Safety, availability and reliability are the main components of a comfortable rail traffic. A system and method for identifying a train-type based on the analysis of rail related data integrating location and train-type signal features will help in understanding delays, infrastructural malfunctioning, etc. The International Union of Railways (IUR), the Community of European Railways (CER), the International Union of Public Transport (IUPT) and the Union of European Railway Industries (UNIFE) have all agreed, within the White Paper for European Transport, to attempt to increase the market share of goods traffic on rail from 8% in 2001 to 15% in 2020 (European Union, 2011). This will of course lead to an increase in railway traffic hence number of trains. Each train has different characteristics and knowing the type of a train will help in establishing the state of both the train itself and of the track, as well as knowing ancillary information about the train, such as its location, ETA, speed, collision susceptibility, etc.

For a ground-based sensor, conventional timetable operation methods for railway traffic control gives no direct positive confirmation that the measurement corresponds to a particular train as the schedule only provides timestamps at particular control points, which can differ from sensor locations. Furthermore, as there are deviations between the actual traffic and the planned schedule, relying on the schedule requires an inconvenient collection of data. This external information may not only contain errors but can also be delayed by days or weeks, hence preventing real-time assessments. For cargo trains, the schedule-based approach to identify trains presents even more problems, as it will not specify the exact type and number of wagons, but rather only a general type and a maximum reserved length.

As the number of trains increases so will the data one can use from them. For example, the vibrations induced by the motion of the train via the interaction between wheel and rail tracks. This vibrational data can be used to extract a lot of information, for example, rail and track bed condition, vehicle suspension, wheel condition, speed, weight of the vehicle, material used in tracks, depth to water table, frost depth, type of the vehicle, etc.

A system and/or a method which will be able to analyse this vibration will not only be able to provide the information about the wheels and the rail tracks but also the vehicle passing by and the traffic associated with the vehicle. As a person skilled in art may now infer that the nature of vibrations and the associated data will differ depending on the point where they are recorded. A few vibration/oscillation-based studies of railway related data have been done:

For example, EP1274979B1 relates to a method for monitoring the travelling behaviour of rail vehicles, according to which an oscillation behaviour of at least one vehicle component is monitored by detecting at least one oscillation pattern and comparing the same with at least one reference oscillation pattern, whereby a natural oscillation of at least one vehicle component is monitored. The invention also relates to a device for monitoring the travelling behaviour of rail vehicles, whereby at least one oscillation pick-up is mounted on at least one vehicle component. To this end, means are provided for evaluating the signal pattern, which is supplied by at least one oscillation pick-up, whereby characteristic values of the oscillation patterns of the at least one vehicle component are detected and compared with reference characteristic values of the oscillation patterns of a natural oscillation of the vehicle component.

CN102343922 provides an on-line monitoring system for vibration characteristics of a rapid railway turnout based on a wireless sensor network and relates to the technical field of safety monitoring of rapid railway infrastructures. The wireless sensor network serves as the core of a special system. The on-line monitoring system comprises a data monitoring unit for front-end three-shaft acceleration wireless sensor, a front-end data collecting unit for the wireless sensor network and a server terminal, wherein the data monitoring unit for front-end three-shaft acceleration wireless sensor is used for on-line acquiring a vibration data of a rapid turnout when a train passes by and sending the vibration data in a wireless mode; the front-end data collecting unit for the wireless sensor network is used for receiving the data sent by the data monitoring unit in real time and collecting and transferring the data; and the server terminal is used for receiving the data from the front-end data collecting unit, permanently storing the data, analysing and calculating to obtain a train speed and a load condition according to the acceleration data, comparing the train speed and the load condition with a historic statistical data, and prompting and alarming for parameters which deviate from the historic statistical data and exceed a certain scope, thereby supporting the safety running of the rapid turnout. Combined with a conventional test and mechanical analysis method, the on-line monitoring system can be used for monitoring the rapid railway turnout and providing a data basis for maintaining and design optimizing of the turnout.

The application PCT/EP2020/053182 discloses a method and system using multiple data sources for unsupervised and/or semi supervised algorithms to derive features such as speed of the train, length of the train, type of wagons, etc. Thus, classifying train categories. a method and a system configured for analysing railway related vibration data are disclosed. A first dataset is collected from a sensor applied to the railway infrastructure and at least a second dataset is collected from a scheduling component. A subset of the first dataset is curated with the second dataset to obtain a first training database. Furthermore, a method comprising the step of predicting at least a likelihood of one train belonging to at least one train-type is disclosed.

The application WO WO2019185873 discloses a method and system for detecting and associating railway related data. The method can comprise the steps of capturing at least a first signal from a first sensor applied to railway infrastructure. The railway structure comprises a sensor that will allow providing sensor information that may be directly or indirectly relevant to the railway. The sensor information can be processed by a first analytical approach to obtain first analytical data. Similarly or differently, it can also comprise capturing at least a second signal from a second sensor and processing the second signal by a second analytical approach to obtain second analytical data. Moreover, the method can comprise the further step of associating the first and second analytical data to obtain associated data. The first analytical data will directly or indirectly influence or have an impact to the second analytical data and/or vice versa.

All of the above-mentioned documents are herein incorporated by reference.

### SUMMARY

In light of the above, it is an object of the present invention to overcome or at least alleviate the shortcomings of the prior art. More particularly, it is an object of the present invention to provide a method and system for classifying a type of the train based on vibrational data captured from a rail. This object is attained with the embodiments in accordance with the present specifications and/or subject matter in accordance with the embodiments and/or claims.

In particular, the present invention relates to a method and system using multiple datasets for unsupervised training of a neural network to classify a train based solely on the captured vibrational data. The vibrational data can be encoded into a plurality of components relating to train-type, location, speed, etc.

According to a first aspect the invention relates to a method for determining a train-type on the basis of railway related vibration data. The method comprises the step of collecting a first dataset of a first train passing a first sensor applied to a first railway segment at a first location and collecting a second dataset of a second train passing a second sensor applied to a second railway segment at a second location.

The method further comprises encoding the first dataset into a first encoded dataset comprising at least a first train-type component and a first location component constituting first encoded dataset components and encoding the second dataset into a second encoded dataset comprising a second train-type component and a second location component constituting second encoded dataset components.

Eventually, the method comprises feeding the first and the second encoded dataset components into a neural network (NN) and applying an unsupervised machine learning approach for training the neural network in order to differentiate between train-types.

A train-type can be a train model, a specific configuration of wagons, a specific railcar, a train travelling at a specific speed, a train with a specific wagon count or a train with a specific axle count, a train with a specific acceleration, respectively acceleration pattern, a train with a specific number of railcars, a train with a specific type of wheels, a train with a specific type of propulsion, respectively engine. Furthermore, a train-type can be a combination of any of the aforementioned parameters to form a complex train-type.

Railway vibration can be defined as the cumulative wave signal generated by the train passing over a specific point or segment on the rail. The vibration can be captured directly at the rail or indirectly by coupling to a transmission medium, i.e., coupling to air.

Generally, the rail can be vibrationally excited by coupling an energy and/or impulse source to the rail. The coupling can be achieved by direct contact between the source and the rail. Specifically, a train being in contact with at least part of the rail can transmit an energy signal respectively an impulse signal to the rail, which excites a vibration of the rail. The generated vibration can be captured over time. Typically, a dataset can be segmented based on an amplitude of the vibration dropping below a threshold value and/or based on a time interval being exceeded. Thus, the dataset may comprise an approach segment of the train approaching the sensor, a passing phase of the train passing the sensor and/or a departing phase of the train moving away from the sensor.

The sensor can be configured to pre-process the collected raw data. In particular the sensor can be a system-on-a-chip (SoC) device configured to filter and transform the raw data. Preferably, the raw data is transformed into spectral data sampled over time, i.e., using FFTs. A railway segment can be an actual piece of railroad rail. The sensor can capture the signal at a single rail or at both rails.

Preferably, the first sensor and/or the second sensor can be configured to each capture a wave signal, in particular a pressure wave signal, respectively a vibrational wave signal. The first sensor and/or the second sensor can each be disposed on a medium, in particular the rail and/or a transfer medium and/or can be configured to capture the wave signal through the contact with the medium and/or rail, i.e., the sensors can be vibrationally coupled to the medium and/or rail.

The first sensor and/or the second sensor can be configured to capture an acceleration, in particular an acceleration the respective sensor is subjected to. The acceleration signal can be correlated to the vibration of the rail. The acceleration can be parallel to a surface-normal of a rail, in particular a rail-surface oriented towards the train wheel. The sensor can be configured to capture acceleration signals for a plurality of spatial directions.

Typically, the first location and the second location are vibrationally uncoupled so as to not have interference in the signal based on capturing the same train at the same time interval, in other words, no overlapped capture. The neural network can be configured to both support variable length input sequences and to predict or output variable length output sequences. The encoder and/or decoder can be represented as a model within the neural network. The encoder can be configured to read the dataset, in particular in a sequential fashion. The encoder can be configured to generate an output representing a learned representation of the input dataset, in particular in a form of a fixed-length vector.

The neural network can incorporate an encoder-decoder architecture to map structured datasets to basic spectral data and vice versa. The network can be recurrent, in particular incorporating a Long Short-Term Memory (LSTM). For a given dataset, an encoder-decoder neural network can be configured to read the input dataset, encode it, decode it, and recreate it. The performance of the network can be evaluated based on the networks ability to recreate the input dataset. The decoder of the network may be reserved for use during training.

The method can comprise the step of composing a first virtual encoded dataset comprising the first train-type component and the second location component. This achieves the advantage of enabling the comparison to the first dataset regarding the train-type component and enabling the comparison to the second dataset regarding the location component. The neural network, respectively the encoder and decoder are configured to reproduce the original components based on the new combination. Preferably, each permutation of the composed virtual datasets comprises a plurality of components wherein only one component differs from a real dataset, i.e., the first dataset or the second dataset. However, a virtual dataset can comprise any combination of available components from real datasets. Each virtual dataset may only contain one component of each type, i.e., only one train-type component and only one location component. Thus, the structure of the virtual dataset may be identical to the structure of the first and second datasets, meaning that the number of components and/or the concatenation of components within the dataset are identical.

Applying an unsupervised machine learning approach for training the neural network can comprise comparing the first encoded dataset with the second encoded dataset and/or the first virtual encoded dataset. A comparison can comprise any type of comparative measure. In particular, the datasets can be compared based on features present within the datasets, i.e., peaks, patterns. Signifying sequences etc. A comparison can also be based on the smallest logical element of the set, i.e., a comparison per numerical element, bit, byte, number etc.

The comparison can comprise a correlation of the datasets to be compared. A comparison of the first dataset with the second dataset can further train the neural network, when it is determined that at least one component of the sets is considered to belong to the same physical feature. In that sense, the method can comprise evaluating two datasets for similar components and/or identifying datasets which comprise potentially identical components. For example, the neural network may determine that a train-type component encoded based on a dataset from the first sensor and a further train-type component encoded based on a dataset from the second sensor may exceed a similarity threshold. This may indicate, that the same train-type passed over the first sensor and the second sensor. Thus, a comparison, respectively generating a similarity measure, based on the assumption that the train-type component from the first dataset and the train-type component from the second dataset ought to be identical, can train the neural network.

Comparing the first encoded dataset with the second encoded dataset and/or the first virtual encoded dataset can comprise determining a similarity measure. The similarity measure can be any type of comparative algorithm that quantifies the difference between datasets, respectively between corresponding dataset components. Determining a similarity measure may comprise placing dataset components within a multi-dimensional parameter space and calculate the distance between the dataset components within this parameter space. Determining a similarity measure may comprise generating a similarity matrix for a set of components, i.e., two location components, where the matrix can contain information of the Euclidean distance between the dataset components with the parameter space. Alternatively, a Gaussian can be used to measure the distance of the dataset components.

The similarity measure can comprise similarity-based metrics: Pearson's correlation, Spearman's correlation, Kendall's Tau, Cosine similarity, Jaccard similarity. The similarity measure can comprise distance-based metrics: Euclidean distance, Manhattan distance. The similarity measure can determine the most similar components with the highest values.

Kendall's Tau is a non-parametric measure of relationship, where the coefficients are calculated based on ranking data and not necessarily the raw data. Kendall's Tau is always between −1 and +1, where −1 suggests a strong, negative relationship between two components and 1 suggests a strong, positive relationship between two components Using Kendall's Tau as a similarity measure can realize the advantage of having a smaller variability when using larger sample sizes. In particular in comparison to Spearman's correlation. Similar to a rank correlation coefficient, Kendall's tau is a measure of the relationship between the observations of two at least ordinally scaled characteristics (x, y) that is robust to outliers. It assumes rank order sorted by characteristic x. It measures how often the rank order of observations of y break this rank order. This number is divided by the number of rankings that are possible in principle. Thus, it is restricted to the interval from minus one to plus one. If the two rankings are identical, there is a perfect correlation and the coefficient takes the value one.

The similarity measure can be determined based on dataset components of the same type. Alternatively, a similarity measure can be determined based on a group of dataset components, in particular a group of datasets components, that are linked by an underlying physical quantity. For example, a train-type component can be grouped with a train-speed component, as these components share the same characterizing origin: Both components are linked to the actual train passing the sensor. The datasets can each comprise the same number and/or the same type of dataset components. The type of a dataset component can be linked to the encoder encoding the specific dataset as the encoder generates the dataset components. Each dataset component may be encoded by a specific encoder configured to generate the respective dataset component. Each encoder may be represented by part of the neural network.

The similarity measure can be iteratively determined on the basis of a plurality of first and second and virtual encoded data sets until the similarity measure exceeds a predetermined similarity measure threshold value. The similarity measure may by a real valued function having a specific form, value and/or composition pertaining to datasets, respectively dataset components which are identical. In other words, the similarity measure can indicate the similarity of the components on some scale. On this scale a threshold can be set which signifies a sufficient similarity between the components. This achieves the advantage that the training of the neural network can be stopped when a sufficient accuracy of recognizing a specific component as belonging to a specific characteristic component is achieved. In other words, the components may form a clustered group within the parameter space, wherein the centre of mass of that group may represent the stereotypical form of the component. When determining the similarity measure of two components generates an unambiguous assignment of the component in question to the stereotypical component, the respective component can be reliably categorized.

For example, the train-type components may form a plurality of grouped clusters within the parameter space, wherein each cluster represents an actual distinct train-type. When the encoder and decoder, respectively the neural network reaches a training state, where each cluster is distinct from the other clusters, each train-type component can be assigned to the specific train-type represented by that cluster. The train-type does not need to be known. The method simply recognizes that the train-type components are recorded from the same type of train, in particular independent of any other components within the dataset.

The subsequent iteration of determining the similarity measure can be adjusted according to at least one previously determined similarity measure.

The method can comprise the step of decoding the first virtual encoded dataset to generate a first virtual dataset. This achieves the advantage of generating a virtual dataset that mimics an actual sensor output. The virtual dataset can then be used as if it would have actually been captured by a real sensor. In particular, the virtual dataset can be used as an input to the decoder.

The method can comprise the step of encoding the first virtual dataset into a first reencoded virtual dataset having first reencoded components. This achieves the advantage of generating a set of mirroring components that, when using an ideal encoder and an ideal decoder can be identical to the initial components used to compose the virtual dataset. The differences introduced by the decoder and/or encoder can represent imperfections in extracting the respective components from datasets. Thus, any mismatch, respectively any non-ideal response from the similarity measure enables an improvement of the components, respectively enables learning for the neural network. The similarity is to be maximized and any differences between the respective components to be minimized. The term respective components relates to the plurality of components, in particular the pair of components, which, by construction of the datasets should be identical to one another.

The first reencoded components can comprise at least a third location component. The third location component can, for example, be the corresponding location component to the first location component of the first dataset. The first reencoded components can comprise at least a third train-type component. The third train-type component can, for example, be the corresponding train-type component to the first train-type component of the first dataset. Thereby, a virtual dataset combining components of two individual real datasets can be composed, wherein each component of the virtual dataset, respectively of the reencoded virtual dataset has a corresponding component in a real dataset. These reencoded components can be compared to the corresponding components to generate a similarity measure. The similarity measure can be generated on a component level and/or on a dataset level. In other words, the similarity of the dataset can be determined. Preferably, the similarity of the individual components, respectively component sets can be determined.

The method can comprise the step of comparing the first train-type component and the third train-type component. This can achieve the advantage of comparing an initially captured and encoded component with a component passed through a decoding and encoding cycle. A measure of comparison can comprise mapping the reencoded component, to the original component and extracting the difference. The comparison measure may comprise a comparison of the component as a whole or a segmented comparison, i.e., parts of each component may be compared. The segments may be temporally and/or spatially linked, i.e., match in time and/or sample length.

The method can comprise the step of determining a similarity measure based on the first train-type component and the third train-type component. A suitable similarity measure can define the accuracy of the reencoded components compared to the original components based on a real captured dataset. Although the actual train-type to which the train-type component corresponds may not be known, this component can still be used to train the neural network, as it is the reproducibility of that component in conjunction with a different set of concatenated components that is evaluated.

The method can comprise the step of comparing the second location component and the third location component. The location component can be an imprint of the sensor environment, rail characteristics and/or ambient parameters onto the signal. These features can be varying or constant. For example, the location component may vary with ambient conditions and/or wear of the components and/or rail. Ambient conditions can comprise, for example, a temperature, humidity, a vibrational noise floor, wind speed, interference from adjacent rails. The method can comprise the step of determining a similarity measure based on the second location component and the third location component. This achieves the advantage of comparing a static element, as the location component can be set to be independent of the train type-component, thus independent of the actual train passing the sensor. The network can be trained to generate a location component in each encoded dataset which achieves the highest similarity to any other location component generated from the specific sensor at that location. Hence variance of location components within different encoded sets from the same sensor shall be minimal. Each variation in the location component produced by reencoding a dataset can be used to optimize the encoder-decoder functions, as optimally the variance is zero.

The method can comprise the step of composing a second virtual encoded dataset comprising the second train-type component and the first location component. The second virtual dataset can be complimentary to the first virtual dataset and represent a mapping of the train captured at the second location to the first location. Thus, for each pair of real datasets having two components, two distinct virtual datasets can be composed and used for training the neural network alongside the real datasets, thereby increasing the training efficiency and quality of the neural network in determining a train-type.

The method can comprise the step of decoding the second virtual encoded dataset to generate a second virtual dataset. The method can comprise the step of encoding the second virtual dataset into a second reencoded virtual dataset having second reencoded components. The second virtual dataset can be processed in accordance with to the first virtual dataset. In particular, each dataset can be encoded by the same encoder and/or each encoded dataset can be decoded by the same decoder.

The second virtual reencoded components can comprise at least a fourth location component. The fourth location component can, for example, be the corresponding location component to the first location component of the first dataset. The second reencoded components can comprise at least a fourth train-type component. The fourth train-type component can, for example, be the corresponding train-type component to the second train-type component of the second dataset. The method can comprise the step of comparing the first location component and the fourth location component.

The method can comprise the step of determining a similarity measure based on the first location component and the fourth location component. Thus, the capability of recreating the original location component in the context of a different train-type component can be tested and used to further train the network. The method can comprise the step of comparing the second train-type component and the fourth train-type component. Similarly, to testing the location component, also the train-type component can be used to test the ability to recreate the original train-type component in the context of another location component. The method can comprise the step of determining a similarity measure based on the second train-type component and the fourth train-type component.

The neural network can comprise a decoder and the method can comprise the step of training the decoder based on the similarity measure. The decoder can be a means of generating datasets to train the encoder. The quality of the decoder and therefore a decoder improved via training can generate datasets indistinguishable from real recorded datasets.

The decoder can be configured to decode an encoded dataset to generate a dataset. The decoder can be an auxiliary component to the encoder as the primary function of the network is to encode components which enable train-type classification and separate any other data components that do not correspond to the characteristics of the train, i.e., are location specific.

The neural network can comprise an encoder and the method can comprise the step of training the encoder based on the similarity measure. Setting a similarity criterion can achieve the advantage of increasing the consistency of the encoder and/or decoder so as to increase the capability to unfold the original signal into its underlying components. Thus, the encoder can be configured to extract a vibrational signature signal in form of a train-type component and separate this signal from signal elements which are characteristic to the location and not the train. The location characteristics can be encoded in the location component.

The encoder can be configured to encode a dataset to generate an encoded dataset. The encoder can be indifferent to the origin of the dataset to be encoded. In particular, the encoder may have no knowledge on whether the dataset to be encoded is a decoded constructed virtual dataset or a real recorded dataset. The encoder can comprise a plurality of specific encoders, wherein each encoder encodes a specific component from the dataset. The encoders may execute in parallel and/or independent of one another. The output of the encoders may be concatenated to form an encoded dataset. A classification can be performed based on the encoded dataset.

The method can comprise the step of determining a wagon count of a train based on an encoded dataset. This can achieve the advantage of providing a further feature to identify the train-type. The train-type can be determined based on the vibrational signature of the train encoded in the train-type component. In addition, the wagon count can further distinguish the recorded train as a specific train-type can be limited to a specific range of wagons.

The method can comprise the step of splitting the encoded dataset based on the wagon count of the train. This achieves the advantage of identifying a train-type based on the characteristics of a single wagon. In particular, the vibrational fingerprint of a single wagon can be extracted. Furthermore, the train can be composed of a plurality of similar or identical wagons. Thus, identifying a wagon can complement identifying the complete train-type. The neural network can be trained with reencoding a plurality of single wagon components.

The method can comprise the step of identifying a train type based on the wagon count. The train-type can be linked to a specific number of wagons, such that identifying the number of wagons narrows the possibilities of the train-type.

The method can comprise the step of determining an axle count of a train based on an encoded dataset. A wheel passing the sensor can identify an axle of the train passing the sensor. A specific pattern of axles can identify a wagon. The axle count may be independent of the wagon count.

The method can comprise the step of splitting the encoded dataset based on the axle count of the train. For example, each axle can be a separate component, wherein each axle is represented by similar characteristics within the encoded dataset. A similarity measure can, for example, be based on the similarity of a characteristic axle. A characteristic axle can be determined based on the plurality of axle representations within the train-type component.

The method can comprise the step of identifying a train type based on the axle count. A broad category of the train can be identified based on the axle count, i.e., freight train, passenger train, long distance passenger train, fast long distance passenger train.

The method can comprise the step of generating an encoded zero representation dataset. The zero-representation dataset can comprise a single component or a set of selected components of one of the encoded datasets, in particular of captured real data, and a set of zeros for the remaining components. Reencoding a zero-representation dataset can achieve the advantage of identifying a transfer of information from the non-zero components to the zero components by the encoder and/or the decoder. To optimize the encoder and decoder this transfer can be minimized by cyclic optimization. Thus, zero representation datasets can be used to further train the neural network. The method can comprise decoding the encoded zero representation dataset to generate a zero-representation dataset. A zero-representation dataset can be an artificial representation which eliminates specific aspects of a real dataset. For example, a superposition of environmental artifacts introduced by the location component can be removed and a pure representation of the train-type component can be subjected to a reencode cycle.

The method can comprise using the zero-representation dataset as a first dataset. This achieves the advantage, that the zero-representation dataset can also be used as an input dataset to train the neural network. The zero representation can be used to quantify the level of training of the encoders since any data generation in the zero components after a reencode cycle can represent a delta to an optimal reencode cycle.

The method can comprise determining a structural similarity index measure (SSIM) based on the first dataset and/or the second dataset and the zero-representation dataset. SSIM can be used as a metric to measure the similarity between two given dataset components. In particular, SSIM can be used to quantify the similarity of each permutation represented as a virtual dataset compared to its corresponding reencoded dataset, respectively the permutated components. SSIM may comprise identifying patterns of repetition in the dataset components. In particular, SSIM can achieve the advantage of measuring a pairwise similarity between components.

SSIM may comprise measuring the distance between intermediate representations of the signal structure or compare the components on a block-based model concentrating on segmenting and clustering sections. This can achieve the advantage of consistently and robustly characterizing a global signal structure within the component and thereby provide a measure for the similarity of components to be compared.

The method can comprise classifying an asset, in particular a train type, based on the train-type component and/or the location component of an encoded dataset, in particular the first encoded dataset and/or the second encoded dataset. More generally, the neural network can be trained to identify any recurring signal structure within the captured data. Any feature that can be initially encoded as a separate component by the encoder can be subject of a cyclic training to increase the consistency of encoding the selected separate component type from a dataset. A specific signal structure can be linked to a specific asset, i.e., a signal caused by a specific action of a specific object.

The method can comprise classifying an asset, in particular a location, based on the location component and/or the train-type component of an encoded dataset, in particular the first encoded dataset and/or the second encoded dataset. Thus, the advantage can be achieved, that the neural network does not require external information regarding the location and/or train-type. In particular, the neural network can identify locations and/or train-types based on the available datasets, in particular without any external classification of the datasets. Each type of component is grouped and identified based on their respective signal structure.

Alternatively, the datasets can be linked by external information, i.e., location information, train schedule information, train-type information. Furthermore, information regarding the location of the sensors can be used to narrow the possibilities of the type of train that caused the respective signal. The datasets can be cross-linked by location in the sense that there is a relation between the locations that can limit the possibilities of train-types. For example, a train may be detected at a plurality of instances along its route. When there are no junctions between two sensors, the network can expect the same train at the first sensor and the second sensor. Each branch along the route may decreases that probability.

The method can comprise performing a root mean square type regression (RMS) based on an encoded dataset, in particular the first encoded dataset and/or the second encoded dataset. The RMS can be performed per each dataset component. This achieves the advantage that the deviation from an ideal dataset component can be estimated. There can be a limited number of train-types. Ideally, each dataset component would be an exact match of the ideal representation of a specific train-type. Practically, the similarity measure for each dataset component would be above a predetermined threshold with reference to the ideal dataset. Thus, the RMS error would be minimal. Increasing similarity of the encoded components within each group of components identified as the same train-type can increase the accuracy of the train classification, respectively decrease the probability of misclassification.

Determining the similarity measure can comprise determining a cycle consistency measure. A cycle consistency measure can comprise determining a cycle consistency loss between two datasets. The cycle consistency measure can enforce forward-backward consistency, meaning that the encoder and decoder will be consistent in their results when the respective output from one module is used as in input for the other module.

A cycle consistent adversarial network can be based on upon two heuristics: adversarial learning and cycle consistency. Adversarial training can learn the encoder and decoder functions that produce respective encoded output datasets, respectively decoded output datasets. Applying a cycle consistency measure in conjunction with adversarial losses can achieve the advantage of increasing the quality of a mapping from an input dataset to a structured encoded dataset as a basis for train identification. Cycle consistency can reduce the space of possible mapping functions. In particular the encoder and decoder can be forward and backward cycle consistent.

The similarity measure can comprise a cycle consistency loss function. The cycle consistency loss function can comprise at least one of the following components:
Representation loss;
Cycle sensor loss;
Cycle root mean square loss;
Cycle train loss;
SSIM loss;
Uncorrelation loss;
Sensor classification loss;
Root mean square regression loss;

A cycle consistency loss can be defined as a difference between the respective encoded dataset components, in particular the corresponding location components or the corresponding train-type components of one of the following combinations:
the first encoded dataset and the first virtual encoded dataset;
the second encoded dataset and the first virtual encoded dataset;
the first encoded dataset and the second virtual encoded dataset;
the second encoded dataset and the first virtual encoded dataset.

The cycle consistency loss function is introduced to the optimization problem to check consistency of the decoder and encoder. Thus, encoding a dataset and then decoding this encoded dataset should yield the same original dataset. The encoder modules are configured to encode a raw sensor dataset into encoded dataset components and the decoder is configured to decode these encoded dataset components back to a cycled raw sensor dataset. The raw sensor dataset and the cycled raw sensor dataset shall be identical or at least similar. The neural network is configured to minimize differences between the raw sensor dataset and the cycled raw sensor dataset. A simple example taken from image conversion would be to convert a zebra image to a horse image and then back to a zebra image. The method should produce the very same input image.

The method can comprise generating the fourth location component by decoding the second virtual encoded dataset and encoding the second virtual dataset, and determining the difference between the first location component and the fourth location component.

The method can comprise generating the third train-type component by decoding the first virtual encoded dataset and encoding the first virtual dataset, and determining the difference between the first train-type component and the third train-type component.

The neural network can be a generative adversarial network, in particular a cycle generative adversarial network.

The method can comprise
collecting a plurality of datasets;
encoding the plurality of datasets into encoded datasets M each comprising a plurality of asset components N;
composing a plurality of virtual encoded datasets L, wherein each virtual encoded dataset comprises a permutation of corresponding dataset components, so that for each encoded dataset M there are (M!−1)×N virtual datasets;
decoding the plurality of virtual encoded datasets into virtual datasets; and
training the neural network using the plurality of virtual datasets as an input to the neural network.

Thus, the method can be expanded beyond the encoding of two components to encoding a plurality of components and generating virtual datasets based on the possible permutations to train the neural network. Preferably, a subset of virtual datasets from all available datasets is used to train the neural network.

The method according to any of the preceding embodiments, wherein the encoded datasets comprise a speed component pertaining to the speed of the train. The speed component can be a third component wherein the neural network can also be trained based on permutations regarding the speed component

The method can comprise referencing the determined train-type to a train schedule information. This provides an additional labelling mechanism, to identify a train-type component or a group of train-type components with contextual information, i.e., the real type of train that has the highest probability of coinciding with the actual captured dataset. This referencing can be carried out independent of the classification of the components.

The first and/or second dataset each comprise at least one of:
frequency data;
displacement data;
velocity data;
acceleration data;

The method can comprise processing the datasets, which comprises at least one of the following steps:
flagging the dataset based on comparing to a noise threshold value;
cropping the dataset;
rescaling the dataset;
transform the dataset to the frequency domain;

The present technology is also defined by the following numbered embodiments:

### Embodiments

Below, method embodiments will be discussed. The letter M followed by a number abbreviates these embodiments. Whenever reference is herein made to method embodiments, these embodiments are meant.

M1. A method for determining a train-type on the basis of railway related vibration data, the method comprising the steps of
collecting a first dataset (101-1) of a first train passing a first sensor applied to a first railway segment at a first location;
collecting a second dataset (101-2) of a second train passing a second sensor applied to a second railway segment at a second location;
encoding the first dataset (101-1) into a first encoded dataset (104-1) comprising at least a first train-type component (102-1) and a first location component (103-1);
encoding the second dataset (101-2) into a second encoded dataset (104-2) comprising a second train-type component (102-2) and a second location component (103-2); and
feeding the first and the second encoded dataset components (104-1, 104-2) into a neural network (NN) and applying an unsupervised machine learning approach for training the neural network in order to differentiate between train-types.
   M2. The method according to any of the preceding embodiments, wherein the first train-type component (102-1) and the first location component (103-1) constitute first encoded dataset components (105-1) and wherein the second train-type component (102-2) and the second location component (103-2) constitute second encoded dataset components (105-2).
   M3. The method according to any of the preceding embodiments comprising the step of
composing a first virtual encoded dataset (106-1) comprising the first train-type component (102-1) and the second location component (103-2).
   M4. The method according to any of the preceding embodiments with features of M3, wherein applying an unsupervised machine learning approach for training the neural network comprises
comparing the first encoded dataset (104-1) with the second encoded dataset (104-2) and/or the first virtual encoded dataset (106-1).
   M5. The method according to any of the preceding embodiments with features of M4, wherein comparing the first encoded dataset (104-1) with the second encoded dataset (104-2) and/or the first virtual encoded dataset (106-1) comprises determining a similarity measure.
   M6. The method according to any of the preceding embodiments with features of M5, wherein the similarity measure is determined based on dataset components of the same type.
   M7. The method according to any of the preceding embodiments with features of M5, wherein the similarity measure is iteratively determined on the basis of a plurality of first and second and virtual encoded data sets (106) until the similarity measure exceeds a predetermined similarity measure threshold value.
   M8. The method according to any of the preceding embodiments with features of M7, wherein the subsequent iteration of determining the similarity measure is adjusted according to at least one previously determined similarity measure.
   M9. The method according to any of the preceding embodiments with features of M5, comprising the step of
decoding the first virtual encoded dataset (106-1) to generate a first virtual dataset (107-1).
   M10. The method according to any of the preceding embodiments with features of M9, comprising the step of
encoding the first virtual dataset (107-1) into a first reencoded virtual dataset (108-1) having first reencoded components (109-1).
   M11. The method according to any of the preceding embodiments with features of M10, wherein the first reencoded components (108-1) comprise at least a third location component (103-3).
   M12. The method according to any of the preceding embodiments with features of M10, wherein the first reencoded components (108-1) comprise at least a third train-type component (102-3).
   M13. The method according to any of the preceding embodiments with features of M12, comprising the step of
comparing the first train-type component (102-1) and the third train-type component (102-3).
   M14. The method according to any of the preceding embodiments with features of M12, comprising the step of
determining a similarity measure based on the first train-type component (102-1) and the third train-type component (102-3).
   M15. The method according to any of the preceding embodiments with features of M12, comprising the step of
comparing the second location component (103-2) and the third location component (103-3).
   M16. The method according to any of the preceding embodiments with features of M12, comprising the step of
determining a similarity measure based on the second location component (103-2) and the third location component (103-3).
   M17. The method according to any of the preceding embodiments comprising the step of
composing a second virtual encoded dataset (106-2) comprising the second train-type component (102-2) and the first location component (103-1).
   M18. The method according to any of the preceding embodiments with features of M17, comprising the step of
decoding the second virtual encoded dataset (106-2) to generate a second virtual dataset (107-2).
   M19. The method according to any of the preceding embodiments with features of M18, comprising the step of
encoding the second virtual dataset (107-2) into a second reencoded virtual dataset (108-2) having second reencoded components (109-2).
   M20. The method according to any of the preceding embodiments with features of M19, wherein the second virtual reencoded components comprise at least a fourth location component (103-4).
   M21. The method according to any of the preceding embodiments with features of M20, wherein the second reencoded components comprise at least a fourth train-type component (102-4).
   M22. The method according to any of the preceding embodiments with features of M20, comprising the step of
comparing the first location component (103-1) and the fourth location component (103-4).
   M23. The method according to any of the preceding embodiments with features of M20, comprising the step of
determining a similarity measure based on the first location component (103-1) and the fourth location component (103-4).
   M24. The method according to any of the preceding embodiments with features of M21, comprising the step of
comparing the second train-type component (102-2) and the fourth train-type component (102-4).
   M25. The method according to any of the preceding embodiments with features of M21, comprising the step of
determining a similarity measure based on the second train-type component (102-2) and the fourth train-type component (102-4).
   M26. The method according to any of the preceding embodiments with features of M5, wherein the neural network comprises a decoder and wherein the method comprises the step of
training the decoder based on the similarity measure.
   M27. The method according to any of the preceding embodiments with features of M26, wherein the decoder is configured to decode an encoded dataset to generate a dataset.
   M28. The method according to any of the preceding embodiments with features of M5, wherein the neural network comprises an encoder and wherein the method comprises the step of
training the encoder based on the similarity measure.
   M29. The method according to any of the preceding embodiments with features of M28, wherein the encoder is configured to encode a dataset to generate an encoded dataset.
   M30. The method according to any of the preceding embodiments, comprising the step of
determining a wagon count of a train based on an encoded dataset.
   M31. The method according to any of the preceding embodiments with features of M30, comprising the step of
splitting the encoded dataset based on the wagon count of the train.
   M32. The method according to any of the preceding embodiments with features of M30, comprising the step of
identifying a train type based on the wagon count.
   M33. The method according to any of the preceding embodiments, comprising the step of
determining an axle count of a train based on an encoded dataset.
   M34. The method according to any of the preceding embodiments with features of M33, comprising the step of
splitting the encoded dataset based on the axle count of the train.
   M35. The method according to any of the preceding embodiments with features of M33, comprising the step of
identifying a train type based on the axle count.
   M36. The method according to any of the preceding embodiments comprising the step of generating an encoded zero representation dataset.
   M37. The method according to any of the preceding embodiments with features of M36, comprising
decoding the encoded zero representation dataset to generate a zero-representation dataset (110).
   M38. The method according to any of the preceding embodiments with features of M37, comprising
using the zero-representation dataset (110) as the first dataset (101-1).
   M39. The method according to any of the preceding embodiments with features of M37, comprising
determining a structural similarity index measure SSIM (111) based on the first dataset (101-1) and/or the second dataset (101-1) and the zero-representation dataset (110).
   M40. The method according to any of the preceding embodiments comprising classifying an asset, in particular a train type, based on the train-type component and/or the location component of an encoded dataset, in particular the first encoded dataset and/or the second encoded dataset.
   M41. The method according to any of the preceding embodiments comprising classifying an asset, in particular a location, based on the location component and/or the train-type component of an encoded dataset, in particular the first encoded dataset (104-1) and/or the second encoded dataset (104-2).
   M42. The method according to any of the preceding embodiments comprising performing a root mean square type regression based on an encoded dataset, in particular the first encoded dataset (104-4) and/or the second encoded dataset (104-2).
   M43. The method according to any of the preceding embodiments with features of M5, wherein determining the similarity measure comprises determining a cycle consistency measure.
   M44. The method according to any of the preceding embodiments with features of M43, wherein the similarity measure and/or the cycle consistency measure comprise a cycle consistency loss function.
   M45. The method according to any of the preceding embodiments with features of M44, wherein the cycle consistency loss function comprises at least one of the following components:
Representation loss;
Cycle sensor loss;
Cycle root mean square loss;
Cycle train loss;
SSIM loss;
Uncorrelation loss;
Sensor classification loss;
Root mean square regression loss;
   M46. The method according to any of the preceding embodiments with features of M43, wherein a cycle consistency loss is defined as a difference between the respective encoded dataset components, in particular the corresponding location components or the corresponding train-type components of one of the following combinations:
the first encoded dataset and the first virtual encoded dataset;
the second encoded dataset and the first virtual encoded dataset;
the first encoded dataset and the second virtual encoded dataset;
the second encoded dataset and the first virtual encoded dataset.
   M47. The method according to any of the preceding embodiments with features of M43, comprising:
generating the fourth location component (103-4) by decoding the second virtual encoded dataset and encoding the second virtual dataset; and
determining the difference between the first location component (103-1) and the fourth location component (103-4).
   M48. The method according to any of the preceding embodiments with features of M43, comprising:
generating the third train-type component by decoding the first virtual encoded dataset and encoding the first virtual dataset; and
determining the difference between the first train-type component (102-1) and the third train-type component (103-3).
   M49. The method according to any of the preceding embodiments wherein the neural network is a generative adversarial network, in particular a cycle generative adversarial network.
   M50. The method according to any of the preceding embodiments comprising
collecting a plurality of datasets;
encoding the plurality of datasets into encoded datasets M each comprising a plurality of asset components N;
composing a plurality of virtual encoded datasets L, wherein each virtual encoded dataset comprises a permutation of corresponding dataset components, so that for each encoded dataset M there are (M!−1)×N virtual datasets;
decoding the plurality of virtual encoded datasets into virtual datasets; and
training the neural network based on the plurality of virtual datasets as an input to the neural network.
   M51. The method according to any of the preceding embodiments, wherein the encoded datasets comprise a speed component pertaining to the speed of the train.
   M52. The method according to any of the preceding embodiments, comprising referencing the determined train type to a train schedule information.
   M53. The method according to any of the preceding embodiments, wherein the first and/or second dataset each comprise at least one of:
frequency data;
displacement data;
velocity data;
acceleration data;
   M54. The method according to any of the preceding embodiments, comprising processing the datasets, which comprises at least one of the steps:
flagging the dataset based on comparing to a noise threshold value;
cropping the dataset;
rescaling the dataset;
transform the dataset to the frequency domain;

Below, system embodiments will be discussed. The letter S followed by a number abbreviates these embodiments. Whenever reference is herein made to sample detection system embodiments, these embodiments are meant.

S1. A train classification system, the system comprising:
a collector module configured to collect a first dataset (101-1) of a first train passing a first sensor applied to a first railway segment at a first location, and configured to collect a second dataset (101-2) of a second train passing a second sensor applied to a second railway segment at a second location; and
an encoder configured to encode the first dataset (101-1) into a first encoded dataset (104-1) comprising at least a first train-type component (102-1) and a first location component (103-1) constituting first encoded dataset components (105-1), and configured to encode the second dataset (101-2) into a second encoded dataset (104-2) comprising at least a second train-type component (102-2) and a second location component (103-2) constituting second encoded dataset components (105-2);
a processing module configured to feed the first and the second encoded dataset components (104-1, 104-2) into a neural network and apply an unsupervised machine learning approach for training the neural network in order to differentiate between train-types.
   S2. The system according to the preceding embodiment wherein the system is configured to execute the method according to any of the method embodiments.
   S3. The system according to any of the preceding embodiments wherein the processing module is configured to compose a first virtual encoded dataset (106-1) comprising the first train-type component (102-1) and the second location component (103-2).
   S4. The system according to any of the preceding embodiments with features of S3, wherein the processing module is configured to compare the first encoded dataset (104-1) with the second encoded dataset (104-2) and/or the first virtual encoded dataset (106-1) and/or to determine a similarity measure based on the first encoded dataset (104-1), the second encoded dataset (104-2) and/or the first virtual encoded dataset (106-1).
   S5. The system according to any of the preceding embodiments, wherein the processing module is configured to iteratively determine a similarity measure on the basis of a plurality of first, second and virtual encoded data sets until the similarity measure exceeds a predetermined similarity measure threshold value.
   S6. The system according to any of the preceding embodiments, wherein the encoder comprises a set of encoder parameters and wherein the processing module is configured to adjust the set of encoder parameters based on a similarity measure, in particular at least one previously determined similarity measure.
   S7. The system according to any of the preceding embodiments with features of S3, comprising a decoder configured to decode the first virtual encoded dataset (106-1) to generate a first virtual dataset (107-1).
   S8. The system according to any of the preceding embodiments with features of S7, wherein the decoder comprises a set of decoder parameters and wherein the processing module is configured to adjust the set of decoder parameters based on at least one previously determined similarity measure.
   S9. The system according to any of the preceding embodiments wherein the encoder is configured to encode the first virtual dataset (106-1) into a first reencoded virtual dataset (108-1) having first reencoded components (109-1), wherein the first reencoded components (109-1) comprise a third location component (103-3) and/or a third train-type component (102-3).
   S10. The system according to any of the preceding embodiments with features of S9, wherein the processing module is configured to determine a similarity measure based on the first train-type component (102-1) and the third train-type component (102-3) and/or configured to determine a similarity measure based on the second location component (103-2) and the third location component (103-3).
   S11. The system according to any of the preceding embodiments wherein the processing module is configured to compose a second virtual encoded dataset (106-2) comprising the second train-type component (102-2) and the first location component (103-1).
   S12. The system according to any of the preceding embodiments with features of S11, wherein the decoder is configured to decode the second virtual encoded dataset to generate a second virtual dataset.
   S13. The system according to any of the preceding embodiments with features of S11, wherein the encoder is configured to encode the second virtual dataset into a second reencoded virtual dataset (108-2) having second reencoded components (109-2), wherein the second reencoded components (109-2) comprise a third location component (103-3) and/or a third train-type component (102-3). to generate second virtual dataset components, in particular comprising a fourth location component and/or a fourth train-type component.
   S14. The system according to any of the preceding embodiments with features of S11, wherein the processing module is configured to compare the first encoded dataset (104-1) with the second encoded dataset (104-2) and/or the second virtual encoded dataset (106-1) and/or to determine a similarity measure based on the first encoded dataset (104-1), the second encoded dataset (104-2) and/or the second virtual encoded dataset (106-2).
   S15. The system according to any of the preceding embodiments with features of, wherein the processing module is configured to determine a similarity measure based on the second train-type component (102-2) and the fourth train-type component (102-4) and/or configured to determine a similarity measure based on the first location component (102-1) and the fourth location component (102-4).
   S16. The system according to any of the preceding embodiments with features of S7, wherein the decoder is configured to decode any encoded dataset to generate a dataset and wherein the encoder is configured to encode any dataset to generate an encoded dataset.
   S17. The system according to any of the preceding embodiments, wherein the processing module is configured to determine a wagon count of a train and/or an axle count of a train based on an encoded dataset and to identify a train type based on the wagon count and/or the axle count.
   S18. The system according to any of the preceding embodiments with features of S5, wherein the processing module is configured to execute a cycle consistency algorithm to train the neural network based on the virtual datasets.
   S19. The system according to any of the preceding embodiments wherein the processing component is configured to group a subset of train-type components of a plurality of train-type components, in particular into a group set representing a single train-type based on a similarity measure.
   S20. The system according to any of the preceding embodiments with features of S19, wherein the processing component is configured to assign a prototype train-type component to each group, wherein the prototype train-type component is assigned based on its distance from the centre of mass in a train type parameter space.
   S21. The system according to any of the preceding embodiments, wherein the processing component is configured to match a train-type component to a train-type group and to determine a probability value representing a likelihood of the train-type component representing the train type associated with the train-type group.
   S22. The system according to any of the preceding embodiments with features of S21, wherein the probability value is proportional to a parameter space distance of the train-type component to the prototype train-type component linked to the specific train type group.

Below, use embodiments will be discussed. These embodiments are abbreviated by the letter “U” followed by a number. Whenever reference is herein made to “use embodiments”, these embodiments are meant.

U1. Use of the system according to any of the preceding system embodiments for carrying out the method according to any of the preceding method embodiments.

Below, embodiments of a computer program product will be discussed. These embodiments are abbreviated by the letter “C” followed by a number. Whenever reference is herein made to the “computer program product embodiments”, these embodiments are meant.

C1. A computer program product comprising instructions, which, when executed by a data-processing system and any of its components according to any of the system embodiments, cause the data-processing system and its components to perform the steps, for which the data-processing system and/or any of its components are configured.
C2. A computer program product comprising instructions, which, when executed by the data-processing system and any of its components according to any of the system embodiments, cause the data-processing system and its respective components to perform the steps of the method according to any of the method embodiments, which method steps are performed by the data-processing system and/or the respective components according to the method.
C3. A computer program product comprising instructions, which, when executed by a sensor-data processing system according to any of the system embodiments, cause the sensor data-processing system to perform the method steps, which method steps are performed by the sensor data-processing system according to the method.

Whenever a relative term, such as “about”, “substantially” or “approximately” is used in this specification, such a term should also be construed to also include the exact term. That is, e.g., “substantially straight” should be construed to also include “(exactly) straight”.

Whenever steps were recited in the above or also in the appended claims, it should be noted that the order in which the steps are recited in this text may be the preferred order, but it may not be mandatory to carry out the steps in the recited order. That is, unless otherwise specified or unless clear to the skilled person, the orders in which steps are recited may not be mandatory. That is, when the present document states, e.g., that a method comprises steps (A) and (B), this does not necessarily mean that step (A) precedes step (B), but it is also possible that step (A) is performed (at least partly) simultaneously with step (B) or that step (B) precedes step (A). Furthermore, when a step (X) is said to precede another step (Z), this does not imply that there is no step between steps (X) and (Z). That is, step (X) preceding step (Z) encompasses the situation that step (X) is performed directly before step (Z), but also the situation that (X) is performed before one or more steps (Y1), . . . , followed by step (Z). Corresponding considerations apply when terms like “after” or “before” are used.

### BRIEF DESCRIPTION OF THE DRAWINGS

FIG. 1 depicts an example of a schematic description of a system configured to execute the method for determining a train-type on the basis of railway related vibration data in accordance with the present invention;

FIG. 2 depicts a further example of a schematic description of a system configured to execute the method for determining a train-type on the basis of railway related vibration data in accordance with the present invention;

### DETAILED DESCRIPTION OF THE DRAWINGS

It is noted that not all the drawings carry all the reference signs. Instead, in some of the drawings, some of the reference signs have been omitted for sake of brevity and simplicity of illustration. Embodiments of the present invention will now be described with reference to the accompanying drawings.

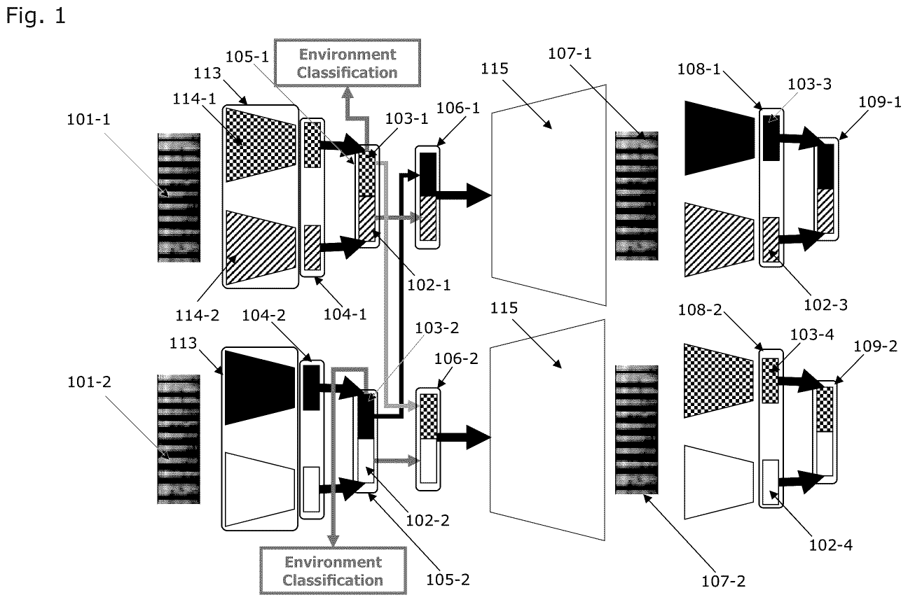

FIG. 1 provides a schematic description of a system configured to execute the method for determining a train-type on the basis of railway related vibration data, for a railway infrastructure.

A first sample 1 is captured at a first location by a first sensor and a second sample 2 is captured at a second location by a second sensor. In particular, the first sensor captures the vibration of a rail when a train is passing the first location. In the same fashion the second sensor captures the vibration of a further rail when a further train is passing the second location. The first and second location are spaced apart. In particular spaced apart far enough so that there is no interference between the first sample and the second sample. Practically, the rail and the further rail are disposed at different railway segments. The train type passing over the respective location can be known to the system by means of a provided train schedule. In an embodiment of the method, the actual train type is not known and the system is configured to determine a train type based on the first sample and/or to determine a further train type base on the second sample.

The first sample 1 and/or the second sample 2 can be provided as a spectral signal over time by the respective sensor forming the first dataset 101-1, respectively the second dataset 101-2. The signal can be a discretized vibrational amplitude spectrum, wherein the signal is discretized in the frequency and time domain. Preferably, the signal is a digital signal. The first and second sensor can be configured to modify the signal by filtering the captured sample.

The system can comprise a collector module configured to collect a first dataset (101-1) of a first train passing a first sensor applied to a first railway segment at a first location, and configured to collect a second dataset (101-2) of a second train passing a second sensor applied to a second railway segment at a second location.

The system further comprises an encoder (113) configured to encode the first dataset (101-1) into a first encoded dataset (104-1) comprising at least a first train-type component (102-1) and a first location component (103-1) constituting first encoded dataset components (105-1). Additionally, the encoder (113) can be configured to encode the second dataset (101-2) into a second encoded dataset (104-2) comprising at least a second train-type component (102-2) and a second location component (103-2) constituting second encoded dataset components (105-2). The encoder 113 can comprise a plurality of encoder modules 114, wherein each encoder module 114 is configured to encode a specific component from the input dataset (101)

The system comprises a processing module configured to feed the first and the second encoded dataset components (104-1, 104-2) into a neural network and apply an unsupervised machine learning approach for training the neural network in order to differentiate between train-types.

The neural network can be a Generative Adversarial Network (GAN) which is configured to configured to train Cycle Consistency (CycleGAN).

The GAN is trained to split the dataset (101-1, 101-2) into a plurality of components, in particular a first component (102-1, 102-2) related to the train itself, a second component (103-1, 103-2) related to the location over which it is passing and/or a third component related to the speed of the train.

Typically, the GAN lacks information that would allow to connect the same train at different locations or the information is incomplete and/or false. Therefore, the system trains the GAN to achieve the goal of identifying a train of an undisclosed train-type at the first location and the same train at the second location. To achieve this, cycle consistency (CycleGAN) is used. CycleGAN implements an unpaired dataset to dataset translation using conditional GAN's. The method can capture the characteristics of one dataset component and learn how these characteristics can be translated into another domain, i.e., another location. The method can realize this in the absence of any paired training examples.

GANs learn a loss that tries to classify if the output, here the specific dataset component, matches the respective dataset component taken from another dataset. The generative model is trained to minimize this loss. CycleGAN uses a cycle consistency loss to enable training without the need for paired data. Thus, it achieves the advantage of translating from one domain to another without a one-to-one mapping between the source and target domain. Therefore, the system can show

[symbol]

Two samples are transformed in parallel. According to an embodiment of the invention, a sample 101-1 of train A at location X and another sample 101-2 from train B at location Y is captured. The sample is encoded to generate encoded information from train B for location Y. In particular two parallel encoders (114-1, 114-2) are used to generate a train-type component B and a location component Y. The same is done for train A at location X. The, a virtual dataset is generated where the location information from X that was found for train A is switched out for the location information from Y. This essentially generates a virtual encoded dataset of train A at location Y. This encoded dataset can be reconstructed as a virtual signal as it would be captured if train A would pass over location Y. The term virtual can be understood as hypothetical or synthetic as train A did not actually pass over location Y. Thus, the virtual signal represents a hypothetical reconstruction signifying how a train A would look like at location Y. This can be done vice versa for train B. This would generate a second virtual dataset representing train B at location X.

Information on the quality of the reconstruction may not be available. However, the GAN can be trained by running the virtual datasets through the encoder 113 and decoder 115 and adding a comparative component based on similarity of the extracted information.

For example, the composed virtual set (train A, location Y) is decoded and then encoded again, generating a reencoded set (train A′, location Y′). The method trains for the original location component Y and the reencoded location component Y′ to be similar. This can be implemented for each component that is part of an original set. The decoder and encoder are part of the neural network and trained on the similarity, respectively lack of similarity after a decode reencode cycle comparison. This achieves cycle consistency.

This achieves the advantage of creating a method to identify trains independent of external information, in particular independent of train schedule information. Furthermore, the system may use any data sample available to train the CycleGAN and thereby avoid a bias towards samples with above average signal to noise (SNR) ratio. In particular, no set of above average signal quality samples is selected to train the network.

The method does not rely on labelled datasets, in particular no labelling with respect to train type and/or based on scheduling information is required. This supports the advantage of avoiding a bias towards cleaner samples, i.e., samples with a high SNR-ratio. Any training of the network may include all available datasets independent of the SNR to increase recognition performance of the method.

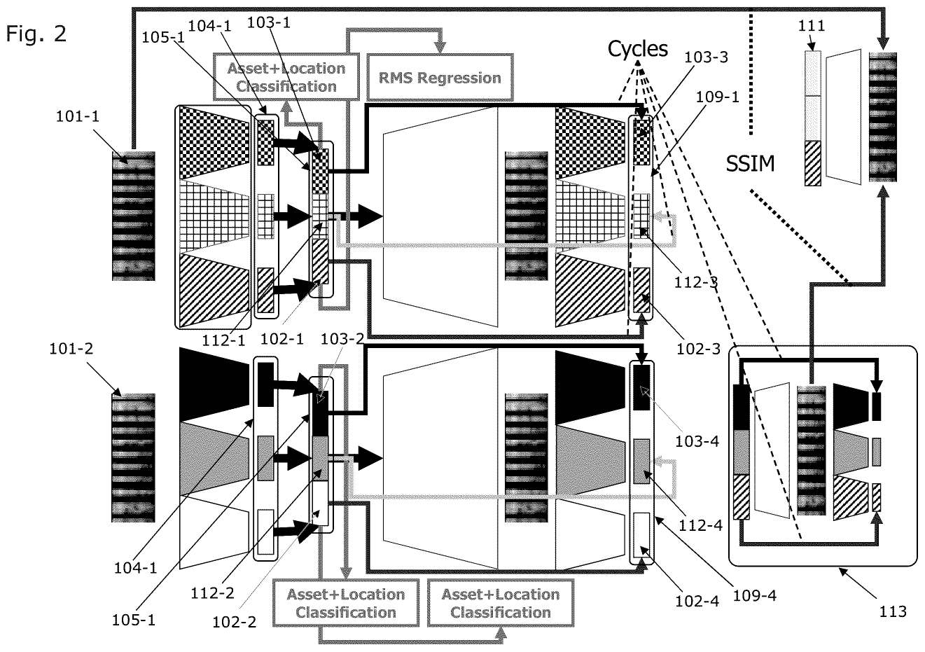

FIG. 2 provides a further schematic description of a system configured to execute the method for determining a train-type on the basis of railway related vibration data, for a railway infrastructure.

In addition to encoding the train-type component (102) and/or the location component (103), the method can comprise encoding a third component, in particular a speed component (112), relating to the speed of the train. This increases the number of permutations (113) available for virtual datasets to train the network. Each permutation that comprises a set of original components with one chosen component exchanged can be compared to the respective original component and thus train the network by determining the similarity measure of the original component and the reencoded chosen component.

The method can comprise integrating a train-type component into a multidimensional train-type parameter space. The distance of train-type components within the parameter space can represent the similarity between the different train-type components. A smaller distance between components signifies greater similarity. Thereby, point-clusters of train-type components in the parameter space can be identified. Each cluster can be labelled as a distinct train-type. Preferably, the method achieves an accuracy, wherein the shape of the point cluster is convex and/or each train-type component has a nearest neighbour which belongs to the same cloud, in other words there is no intersection of point clouds, and/or ambiguity for each train-type component to which cloud it belongs.

Each component can be vector or matrix. Furthermore, the components can be concatenated to form the encoded dataset. The Basic form can be a set of vectors, concatenated to form a single encoded dataset vector.

The method can comprise generating a zero-representation dataset 111 which comprises a single component of one of the encoded datasets, in particular of captured real data, and a set of zeros for the remaining components. The zero-representation dataset 111 can then be reencoded, specifically decoded and encoded. The reencoded zero representation dataset may comprise nonzero elements within the previously set to zero components. This may be used to further train the encoder 113 and decoder 115, as in an ideal algorithm, there would be no transfer into the set of zeros.

The method can comprise applying a structural similarity index measure (SSIM) to each dataset, in particular each reencoded dataset. An ideal decoder and encoder would produce the exact same dataset that was given as an input as the output dataset.

SSIM is used as a metric to measure the similarity between two given dataset components. In particular, SSIM can be used to quantify the similarity of each permutation represented as a virtual dataset compared to its corresponding reencoded dataset, respectively the permutated components.

SSIM may comprise using recurrence plot analysis to characterize patterns of repetition in the dataset components. Additionally, SSIM may comprise generating a normalized compression distance, as a practical approximation of the joint Kolmogorov complexity, to measure the pairwise similarity between the plots.

SSIM may comprise measuring the distance between intermediate representations of the signal structure or compare the components on a block-based model concentrating on segmenting and clustering sections. This can achieve the advantage of consistently and robustly characterizing a global signal structure within the component and thereby provide a measure for the similarity of components to be compared.

Each encoded component output from the decoder can be used as an input to a train-type classification module and more generally an asset classification module. The train-type classification module may be configured to group the train-type components, in particular, apply grouping based on a plurality of parameters. Grouping may be achieved by referencing the respective train-type component as a point in a multi-dimensional parameter space. Additionally, the classification module may be configured to assign a classifying label to a group of train-type components, in particular to a group train-type components which forms a cluster in the train-type parameter space.

Furthermore, the system may comprise a location classification module configured to group the location components, in particular, apply grouping based on a plurality of location parameters. This can achieve the advantage of grouping similar locations, identify the origin of a dataset, respectively assign a location label to the respective dataset.

With each cycle of comparing original and reencoded components the decoder and encoder can be adjusted to minimize a cycle loss function. Constructing a virtual dataset based on a permutation of captured datasets, then reencoding said virtual dataset and generating the similarity measure based on the permutated component and the respective original component can be defined as a cycle. Each cycle, respectively iteration can be used to train the neural network to optimize the output of its encoder and its decoder functions. The encoder and decoder may be emulated by the neural network.

1-15. (canceled)

16. A method for determining a train-type on the basis of railway related vibration data, the method comprising the steps of:
collecting a first dataset of a first train passing a first sensor applied to a first railway segment at a first location;
collecting a second dataset of a second train passing a second sensor applied to a second railway segment at a second location;
encoding the first dataset into a first encoded dataset comprising at least a first train-type component and a first location component;
encoding the second dataset into a second encoded dataset comprising a second train-type component and a second location component; and
feeding the first and the second encoded dataset components into a neural network (NN) and applying an unsupervised machine learning approach for training the neural network to differentiate between train-types.

17. The method according to claim 16, comprising:
composing a first virtual encoded dataset comprising the first train-type component and the second location component, and
comparing the first encoded dataset with the first virtual encoded dataset,
wherein comparing the first encoded dataset with the first virtual encoded dataset comprises determining a similarity measure.

18. The method according to claim 17, comprising the step of decoding the first virtual encoded dataset to generate a first virtual dataset, the method further comprising:
encoding the first virtual dataset into a first reencoded virtual dataset having first reencoded components,
wherein the first reencoded components comprise at least a third train-type component
determining a similarity measure based on the first train-type component and the third train-type component.

19. The method according to claim 17, wherein the neural network comprises a decoder and an encoder and wherein the method comprises training the decoder and/or the encoder based on the similarity measure.

20. The method according to claim 16, comprising determining a wagon count of a train based on an encoded dataset; and identifying a train type based on the wagon count.

21. The method according to claim 16, comprising
generating an encoded zero representation dataset;
decoding the encoded zero representation dataset to generate a zero-representation dataset; and
determining a structural similarity index measure based on the first dataset and the zero-representation dataset.

22. The method according to claim 16, wherein determining the similarity measure comprises determining a cycle consistency measure comprising a cycle consistency loss function.

23. The method according to claim 16, comprising:
collecting a plurality of datasets;
encoding the plurality of datasets into encoded datasets M each comprising a plurality of asset components N;
composing a plurality of virtual encoded datasets L, wherein each virtual encoded dataset comprises a permutation of corresponding dataset components, so that for each encoded dataset M there are (M!−1)×N virtual datasets;
decoding the plurality of virtual encoded datasets into virtual datasets; and
training the neural network based on the plurality of virtual datasets as an input to the neural network.

24. The method according to claim 16, comprising classifying an asset, in particular a train type, based on the train-type component and/or the location component of an encoded dataset, in particular the first encoded dataset and/or the second encoded dataset.

25. The method according to claim 17, wherein determining the similarity measure comprises determining a cycle consistency measure.

26. The method according to claim 25, wherein the similarity measure and/or the cycle consistency measure comprise a cycle consistency loss function.

27. A train classification system, comprising:
a collector module configured to collect a first dataset of a first train passing a first sensor applied to a first railway segment at a first location, and configured to collect a second dataset of a second train passing a second sensor applied to a second railway segment at a second location;
an encoder configured to encode the first dataset into a first encoded dataset comprising at least a first train-type component and a first location component constituting first encoded dataset components, and configured to encode the second dataset into a second encoded dataset comprising at least a second train-type component and a second location component constituting second encoded dataset components; and
a processing module configured to feed the first and the second encoded dataset components into a neural network and apply an unsupervised machine learning approach for training the neural network in order to differentiate between train-types.

28. The system according to claim 27, wherein the processing module is configured to compose a first virtual encoded dataset comprising the first train-type component and the second location component, and
wherein the processing module is configured to determine a similarity measure based on the first encoded dataset and the first virtual encoded dataset.

29. The system according to claim 27, wherein the processing module is configured to iteratively determine the similarity measure on the basis of a plurality of first, second and virtual encoded data sets until the similarity measure exceeds a predetermined similarity measure threshold value.

30. The system according to claim 27, wherein the encoder comprises a set of encoder parameters and wherein the processing module is configured to adjust the set of encoder parameters based on a similarity measure.

31. The system according to claim 27, wherein the processing component is configured to group a subset of train-type components of a plurality of train-type components into a group set representing a single train-type based on a similarity measure.

32. The system according to claim 27, wherein the processing component is configured to match a train-type component to a train-type group and to determine a probability value representing a likelihood of the train-type component representing the train type associated with the train-type group.

33. The system according to claim 27, wherein the processing module is configured to determine a wagon count of a train and/or an axle count of a train based on an encoded dataset and to identify a train type based on the wagon count and/or the axle count.

34. The system according to claim 27, wherein the processing component is configured to match a train-type component to a train-type group and to determine a probability value representing a likelihood of the train-type component representing the train type associated with the train-type group.

35. A computer program product comprising instructions, which, when executed by the system and any of its components according to claim 27, cause the system and its respective components to:
collect a first dataset of a first train passing a first sensor applied to a first railway segment at a first location;
collect a second dataset of a second train passing a second sensor applied to a second railway segment at a second location;
encode the first dataset into a first encoded dataset comprising at least a first train-type component and a first location component;
encode the second dataset into a second encoded dataset comprising a second train-type component and a second location component; and
feed the first and the second encoded dataset components into a neural network (NN) and apply an unsupervised machine learning approach for training the neural network to differentiate between train-types.
